(19) United States
(12) Patent Application Publication
(10) Pub. No.: US 2015/0315003 A1
(43) Pub. Date: Nov. 5, 2015

(54) BOTTLE CORK EXTRACTION DEVICE

(71) Applicant: MICHAEL W. STORMS, Cincinnati, OH (US)

(72) Inventor: MICHAEL W. STORMS, Cincinnati, OH (US)

(21) Appl. No.: 14/700,714

(22) Filed: Apr. 30, 2015

Related U.S. Application Data
(60) Provisional application No. 61/987,645, filed on May 2, 2014.

(51) Int. Cl. B67B 7/04; A45F 5/00

(52) U.S. Cl. CPC B67B 7/04; A45F 5/00; A45F 2005/008

(57) ABSTRACT

A bottle cork extraction device and method of use comprising (1) a handle; (2) a helical extraction coil for threadingly engaging a cork having a first end to engage the cork and an adjacent second end operatively associated with the handle; (3) a unidirectional rotation means for rotating the helical extraction coil to thread into a cork; (4) a housing surrounding the helical extraction coil; and (5) a strap forming an enclosed loop adjacent to the helical extraction coil housing. A bracelet used to store a bottle cork extraction device comprising (1) a handle pivotally attached to a helical extraction coil with a first end and second adjacent end; (2) a housing surrounding the helical extraction coil; and (3) a strap having a first end and an adjacent second end, with a means for forming an enclosed loop adjacent to the helical extraction coil housing.

### RELATED APPLICATIONS

This application claims priority to U.S. Provisional Application No. 61/987,645 filed May 2, 2014. The entire contents of the above application are hereby incorporated by reference as though fully set forth herein.

### FIELD

The present invention relates to the field of bottle cork extraction devices with corkscrews. More specifically, the present invention relates to wearable and/or storable bottle cork extraction devices with corkscrews that are moveable from one storage position on a user's arm or around another object to another position that is operable to extract a cork.

### BACKGROUND

The present invention relates generally to a wearable and/or storable device used to extract a cork from a bottle, such as a wine bottle. The bottle cork extraction device is necessary due to the snug fit of a cork in the bottle. While most bottle cork extraction devices are easily transported, it is generally impractical to carry a bottle cork extraction device while on the go and they are unable to be stored in a place that is quickly accessible by the user. This is problematic to users who must resort to storing the device in their pockets, purses and/or waistbands of their clothing. Additionally, the sharp ends of the coils used in the corkscrew can tear the user's storage garments. As such, coiled cork removal tools do not have a simple way of transportation nor do they offer a convenient housing for easy transportation and protection from the sharp end of the coil.

### BRIEF SUMMARY OF THE INVENTION

It is the object of the present invention to address several challenges in previous attempts to transport and store a bottle cork extraction device for a corked bottle. The present invention is generally a bottle cork extraction device comprising (1) a handle; (2) a helical extraction coil for threadingly engaging a cork having a first end to engage the cork and an adjacent second end operatively associated with the handle; (3) a unidirectional rotation means for rotating the helical extraction coil to thread into a cork; (4) a housing surrounding the helical extraction coil; and (5) a strap having a first end and an adjacent second end, with a means for forming an enclosed loop adjacent to the helical extraction coil housing.

A further embodiment of the present invention is a bracelet used to store a bottle cork extraction device comprising (1) a handle pivotally attached to a helical extraction coil with a first end and second adjacent end; (2) a housing surrounding the helical extraction coil; and (3) a strap having a first end and an adjacent second end, with a means for forming an enclosed loop adjacent to the helical extraction coil housing.

An additional embodiment of the present invention is a method for storing a bottle cork extraction device wherein the device has (1) a first unfolded position with (a) a handle, (b) pivot arm and (c) a helical extraction coil with (i) a first end and (ii) an adjacent end in a perpendicular arrangement to the handle and (2) a second folded position with the helical extraction coil in a parallel arrangement to the handle. The device further comprises a strap with a plurality of bore holes connected to the pivot arm. The method for storing the bottle cork extraction device comprises the steps of (1) folding the helical extraction coil parallel against the handle; (2) inserting the first end of the helical extraction coil into the strap bore holes; (3) rotating the handle and pivot arm to thread the helical extraction coil into the strap bore holes; and (4) creating a closed loop in the strap between the pivot arm and helical extraction coil around an object.

### BRIEF DESCRIPTION OF THE DRAWINGS

FIG. 1 is side view of the present invention as used to uncork a wine bottle.

FIG. 2 is a side exploded view of the present invention with the strap portion shown in a loop configuration.

FIG. 3 is a perspective view of the present invention with the coil portion threaded into the strap portion.

FIG. 4 is a side view of the present invention with the strap portion shown in a loop configuration.

FIG. 5 is a close up side view of the coil portion in the protective housing with the handle portion in a folded position.

### DETAILED DESCRIPTION

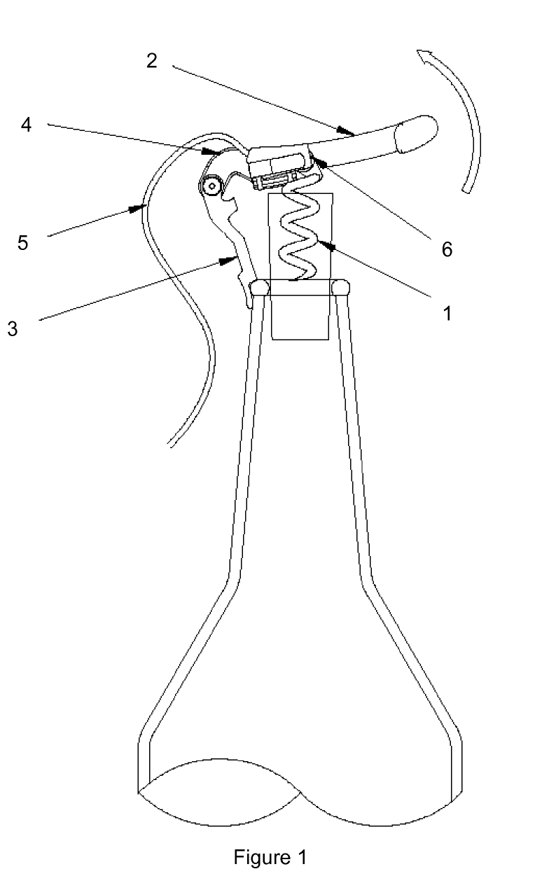

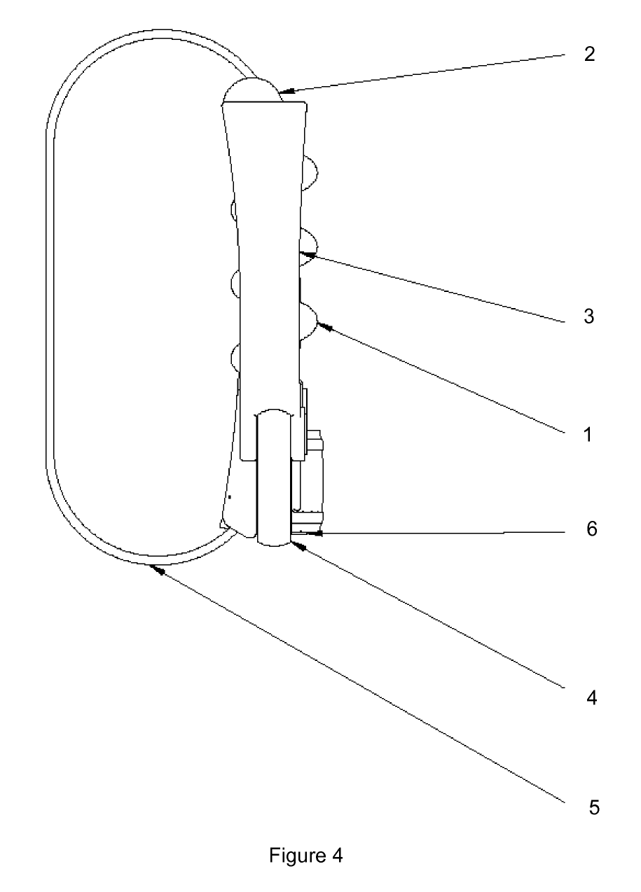

Turning to FIG. 1, a bottle cork extraction device is shown with its handle 3 that turns a helical extraction coil 1 for threadingly engaging a cork. The first end of the coil 1 engages the cork and an adjacent second end of the coil 1 is operatively associated with the handle 3 thereby creating a unidirectional rotation means for rotating the helical extraction coil 1 to thread into a cork. A housing surrounding the helical extraction coil 2 is used as a pry handle during cork extraction and as an extraction coil 1 housing during storage. A strap 5 has a first end attached to a pivot arm 4 and an adjacent second end that hangs loose during cork extraction and forms an enclosed loop adjacent to the helical extraction coil housing 1 during storage (See FIG. 4 for loop formation).

The handle 3 is pivotally associated with the helical extraction coil 1 and it may rest perpendicular to the helical extraction coil 1 or parallel to the helical extraction coil 1.

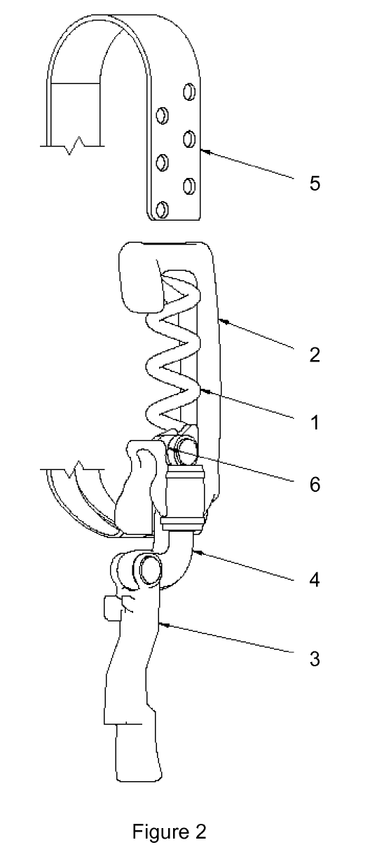

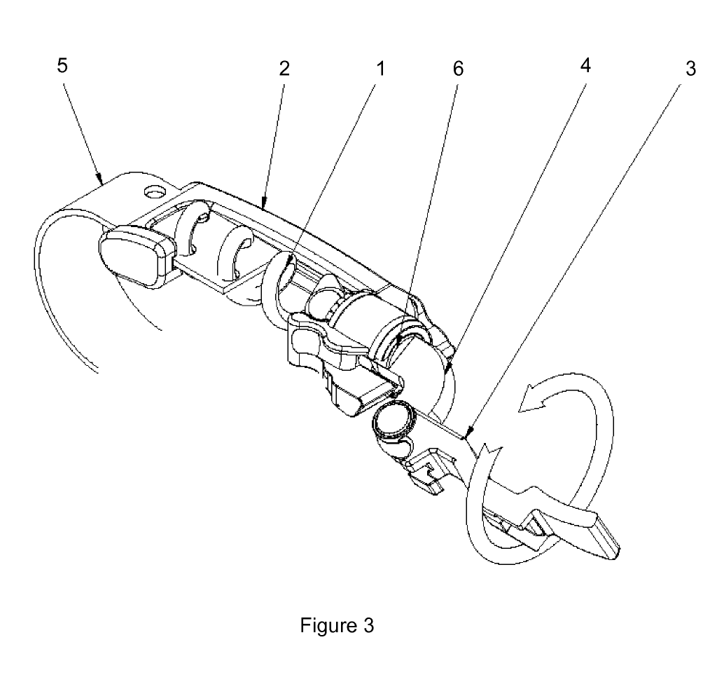

Turning to FIG. 2, the strap 5 comprises a plurality of bore holes. As shown in FIG. 3, the first end of the helical extraction coil 1 is threaded through the plurality of bore holes during storage by turning the handle 3. In the preferred embodiment, a unidirectional rotation means is adjacent to the end of the helical extraction coil 1. In the preferred embodiment, the attachment means is a pivot arm 4 positioned substantially at the junction between the unidirectional rotation means and the helical extraction coil 1 and the adjacent end of the helical extraction coil 1 is permanently attached to the pivot arm 4.

The helical extraction coil 1 may be right-handed thread and the unidirectional rotational direction is similarly right-handed. Alternatively, the helical extraction coil 1 may be left-handed thread and the unidirectional rotational direction is similarly left-handed.

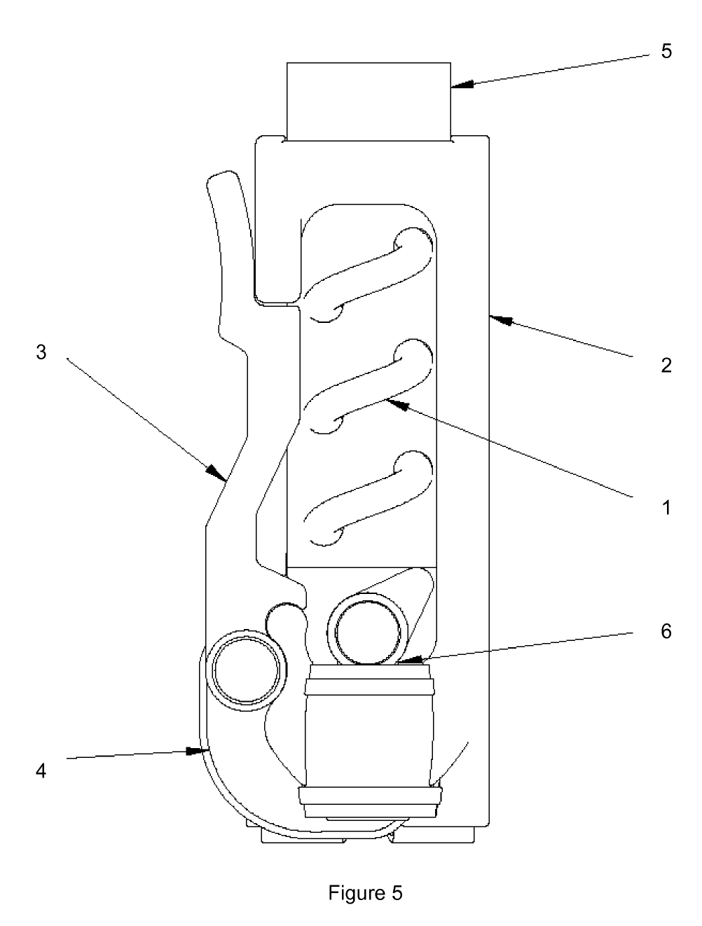

As shown further in FIGS. 2-5, a further embodiment of the present invention is a bracelet used to store a bottle cork extraction device. The handle 3 is pivotally attached to a helical extraction coil 1 with a first end and second adjacent end.

A coil housing 2 surrounds the helical extraction coil 1 and the strap 5 has a first end and an adjacent second end and forms an enclosed loop (See FIG. 4) adjacent to the helical extraction coil housing. The extraction coil 1 rests inside the coil housing 2.

Finally, a further embodiment of the present invention is a method for storing a bottle cork extraction device wherein the device has (1) a first unfolded position with (a) a handle 3, (b) pivot arm 4 and (c) a helical extraction coil 1. As shown in FIG. 1, the helical extraction coil 1 has a first end and an adjacent end in a perpendicular arrangement to the handle 3 during cork extraction. As shown in FIGS. 2-5, the helical extraction coil 1 has a second folded position with the helical extraction coil 1 in a parallel arrangement to the handle 4. The device further comprises a strap 5 with a plurality of bore holes connected to the pivot arm 4. The method for storing the bottle cork extraction device generally comprises the steps of (1) folding the helical extraction coil 1 parallel against the handle 4; (2) inserting the first end of the helical extraction coil 1 into the strap 5 bore holes; (3) rotating the handle 3 and pivot arm 4 to thread the helical extraction coil 1 into the strap 5 bore holes; and (5) creating a closed loop in the strap 5 between the pivot arm 4 and helical extraction coil 1 around an object. In the preferred embodiment, the object is the user's wrist.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A bottle cork extraction device comprising:
a. A handle;
b. A helical extraction coil for threadingly engaging a cork having a first end to engage the cork and an adjacent second end operatively associated with the handle;
c. A unidirectional rotation means for rotating the helical extraction coil to thread into a cork;
d. A housing surrounding the helical extraction coil; and
e. A strap having a first end and an adjacent second end, with a means for forming an enclosed loop adjacent to the helical extraction coil housing.

2. The device of claim 1 wherein the handle is pivotally associated with the helical extraction coil.

3. The device of claim 2 wherein the handle is perpendicular to the helical extraction coil.

4. The device of claim 2 wherein the handle is parallel to the helical extraction coil.

5. The device of claim 1 wherein the strap comprises a plurality of bore holes.

6. The device of claim 5 wherein the first end of said helical extraction coil is threaded through the plurality of bore holes.

7. The device of claim 1 further comprising an attachment means for securing the unidirectional rotation means to the adjacent end of the helical extraction coil.

8. The device of claim 7 wherein the attachment means is a pivot arm positioned substantially at the junction between the unidirectional rotation means and the helical extraction coil.

9. The device of claim 8 wherein the adjacent end of said helical extraction coil is permanently attached to the pivot arm.

10. The device of claim 1 wherein the helical extraction coil has a right-handed thread and the unidirectional rotational direction is similarly right-handed.

11. The device of claim 1 wherein the helical extraction coil has a left-handed thread and the unidirectional rotational direction is similarly left-handed.

12. A bracelet used to store a bottle cork extraction device comprising:
a. A handle pivotally attached to a helical extraction coil with a first end and second adjacent end;
b. A housing surrounding the helical extraction coil; and
c. A strap having a first end and an adjacent second end, with a means for forming an enclosed loop adjacent to the helical extraction coil housing.

13. The bracelet of claim 12 wherein the strap comprises a plurality of bore holes.

14. The bracelet of claim 13 wherein the first end of said helical extraction coil is threaded through the plurality of bore holes.

15. The bracelet of claim 14 further comprising a unidirectional rotation means for rotating the first end of the helical extraction coil to thread into the strap.

16. The bracelet of claim 15 further comprising an attachment means for securing the unidirectional rotation means to the adjacent end of the helical extraction coil.

17. The device of claim 16 further comprising a pivot arm wherein the attachment means is the pivot arm positioned substantially at the junction between the unidirectional rotation means and the helical extraction coil.

18. The device of claim 17 wherein the adjacent end of said helical extraction coil is permanently attached to the pivot arm.

19. A method for storing a bottle cork extraction device wherein the device has (1) a first unfolded position with (a) a handle, (b) pivot arm and (c) a helical extraction coil with (i) a first end and (ii) an adjacent end in a perpendicular arrangement to the handle and (2) a second folded position with the helical extraction coil in a parallel arrangement to the handle; wherein the device further comprises a strap with a plurality of bore holes connected to the pivot arm; the method for storing the bottle cork extraction device comprising the steps of:
(1) folding the helical extraction coil parallel against the handle;
(2) inserting the first end of the helical extraction coil into the strap bore holes;
(3) rotating the handle and pivot arm to thread the helical extraction coil into the strap bore holes; and
(4) creating a closed loop in the strap between the pivot arm and helical extraction coil around an object.

20. The method of claim 19 wherein the object is a user's wrist.
